(19) United States
(12) Patent Application Publication
(10) Pub. No.: US 2003/0178864 A1
(43) Pub. Date: Sep. 25, 2003

(54) Device for accommodating a wafer

(76) Inventor: Erich Thallner, Scharding (AT)

Correspondence Address: MARK KUSNER COMPANY LPA, HIGHLAND PLACE SUITE 310, 6151 WILSON MILLS ROAD, HIGHLAND HEIGHTS, OH, 44143

(21) Appl. No.: 10/388,131

(22) Filed: Mar. 13, 2003

(30) Foreign Application Priority Data
Mar. 21, 2002 (DE) 102 12 420.5

(51) Int. Cl. B25J 15/06

(52) U.S. Cl. 294/64.3

(57) ABSTRACT

The invention relates to a device comprising a carrier for accommodating a wafer within a wafer treatment device.

The invention relates to a device comprising a carrier for accommodating a wafer within a wafer treatment device.

According to the invention, the term “wafer” refers to all types of disc-shaped objects, including in particular silicon discs which are used in the production of semiconductors.

The wafers are processed and treated in different process steps which include for example the adjusting, etching, coating or cleaning of wafers or wafer surfaces.

The accommodation part of these devices is usually referred to as a chuck.

Known arrangements for the treatment of wafers comprise such a device (a chuck) comprising a carrier for accommodating the wafer, wherein the wafer can be positioned in various ways on or at the carrier.

EP 0 444 714 B1 describes various known devices and associated methods, among others a device which operates according to the so-called Bernoulli principle. In this principle, gas is admitted by way of a channel which leads to the carrier surface, with the gas admitted in this way subsequently being drawn off again. This creates a negative pressure between the carrier and the wafer, with the result being a contactless guide of the wafer on the carrier.

Alternatively and/or cumulatively, mechanical devices for guiding the wafer are known, for example by way of so-called pins which grip, centre and hold the wafer along its circumference.

As in all procedural steps in connection with the production of semiconductors, in this context too, dust or other impurities must be precluded as far as possible. This requires regular cleaning of the devices. Since the above-mentioned chucks are usually firmly integrated in the wafer processing plants, changing and cleaning the chuck are difficult.

When cleaning the components, which are usually made from metal, the cleaning agents used can cause contamination which can subsequently be transferred to the wafer to be processed.

Exchangeable chucks are known in apparatus where wafers are coated, for example using photosensitive resist. Usually the entire chuck has to be cleaned.

It is the object of the invention to disclose an option for simplifying the above-mentioned cleaning.

The invention is based on the idea of no longer arranging the wafer to be processed directly on the carrier, but instead on an intermediate component, said component being easy to exchange.

This precludes any contamination of the carrier unit which is difficult to dismantle. The intermediate element (which is a type of adaptor) can easily be removed and exchanged by a new component. This not only makes cleaning as such easier but also faster and more economical.

In this respect, the invention in its most general embodiment relates to a device comprising a carrier for accommodating a wafer within a wafer treatment device, wherein an exchangeable intermediate element is arranged between the carrier and the wafer.

The intermediate element can be attached to the carrier such that it follows the movements of the carrier. In numerous treatments of the wafer, the carrier rotates. Since in the device according to the invention, the intermediate element is used for the actual accommodation of the wafer, the intermediate element has to rotate accordingly. Usually, the drive movement will be provided by way of the actual carrier, however, rotation is transferred to the intermediate element in a suitable way.

To this effect, the intermediate element can for example be mechanically attached to the carrier. Groove and tongue connections, gudgeon-slot connections, or bayonet-type fittings or the like are some examples.

It is also possible to indirectly interconnect the intermediate element and the carrier. For example, the intermediate element can be held with respect to the carrier surface according to the Bernoulli principle. In other words, fixing of the intermediate element onto the carrier can be achieved using the same means as are used in the connection between wafer and carrier, as is for example described in the state of the art cited above. Suitable embodiments are inter alia also described in U.S. Pat. No. 3,523,706 A.

The device according to the invention makes it possible as well for the wafer to be placed on the intermediate element, using the Bernoulli principle. To this effect, the intermediate element for example comprises apertures which are in flow connection to a gas inlet or gas outlet unit arranged at the carrier. The wafer can also be held by suction by means of such apertures in the intermediate element.

For example, zones can be formed which are concentric in relation to each other, wherein in an inner zone the intermediate element is guided along the carrier, while in an outer zone, which is concentric to said inner zone, the wafer is guided on the intermediate element.

The above description of some embodiments shows that a plate-shaped intermediate element meets the required characteristics well and also saves space. A disc-shaped geometry presents itself as a solution, with the intermediate element being of the same size as, or of a larger size than, the wafer to be treated.

Usually, the wafers are circular discs which may be flattened at a particular position of their circumferential region. In such a case, the shape of the intermediate element may be analogously. However, the diameter of the intermediate element can also be slightly larger so that said element protrudes all around from the wafer to be treated.

The intermediate element can be made of various materials. One embodiment provides for the intermediate element to be made of the same material the wafer has been made of.

The above provides an advantage in that the change chuck (the intermediate element) can be treated using the same cleaning agents and cleaning methods as the process wafer.

Any mechanical fixing means too, can be made of this material, for example of silicon. Similarly, the mechanical fixing means can for example comprise glass such as Pyrex glass or the like. This material, just like the material of the wafer/intermediate element, can be cleaned without any problems, using known methods.

In a device according to the invention or in an associated treatment device, the actual chuck (carrier) requires no cleaning or requires cleaning only at significantly longer intervals because any impurities arise directly on the intermediate element. This also applies to contamination due to treatment liquids, for example etchants or liquid rinsing agents that are applied to the wafer during various treatment steps, wherein, however, contamination of adjacent components of the device cannot always be avoided.

Further features of the invention are disclosed in the features of the subclaims and in the remainder of the application documentation.

Below, the invention is explained in more detail by means of one embodiment. The following are shown in diagrammatic representation;

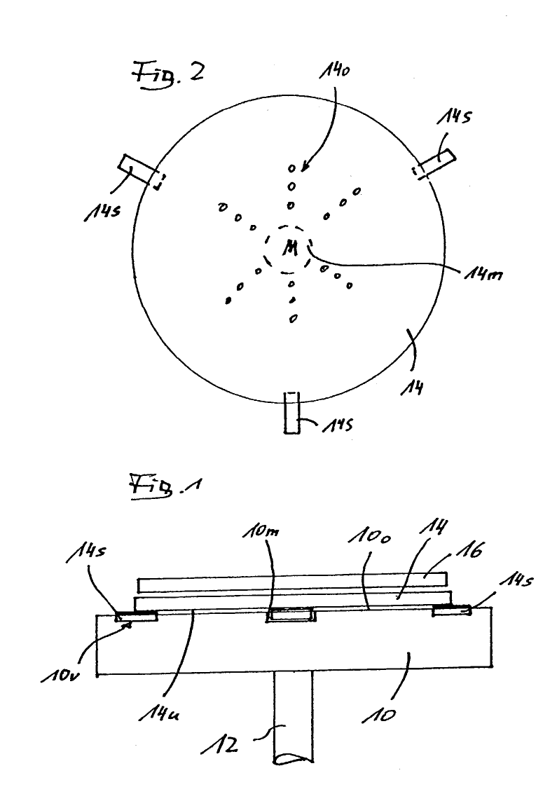

FIG. 1: a vertical section of a device according to the invention; and

FIG. 2: a top view of the intermediate element used in the device shown in FIG. 1.

FIG. 1 shows a carrier 10 comprising an associate drivable shaft 12.

Usually, a wafer rests directly or indirectly (for example according to the Bernoulli principle) on the surface 10o of the carrier 10.

In contrast, the device according to the invention is designed so that an intermediate element 14 is arranged on the surface 10o of the carrier 10, as follows:

Three groove-shaped indentations 10v are provided the circumference and on the surface 10o of the carrier 10, with said groove-shaped indentations 10v being mutually arranged at an angle of 120°. The indentations 10v extend radially in relation to the shaft 12.

A strip 14s of the intermediate element 14 is positioned in each indentation 10v, so as to be free of any play. The strips 14s, which are made from Pyrex glass, are bonded to the underside 14u of the adaptor 14.

As shown in the top view according to FIG. 2, the strips 14s are positioned in the 10, 2 and 6 o'clock position of a clock.

Concentric in relation to the centre M of the disc-shaped intermediate element 14, a further strip 14m, made of Pyrex glass, is bonded to the underside, with said strip being positioned in a corresponding centre aperture 10m of the carrier 10.

The element 14 could also be guided on the carrier 10 according to the Bernoulli principle.

As shown in FIG. 2, the intermediate element 14 comprises a number of apertures 14o which are arranged radially in relation to the centre M, in six rows, thus forming a kind of star pattern in top view.

Below the apertures 14o, groove-shaped channels (not shown) are arranged in the surface 10o of the carrier 10, said groove-shaped channels being connected to a negative-pressure line, so that air is removed by suction along said apertures 14o, which results in negative pressure.

This negative pressure is used to place (hold by suction) a wafer 16 to be treated, on the intermediate element 14.

The provision that the intermediate element 14 can be made from the same material as the wafer 16 to be processed constitutes a particular characteristic of the invention. Accordingly, the intermediate element 14 can be a silicon disc which is identical, from the point of view of material, and if need be also from the point of view of geometric shape, to the silicon disc 16 (in the embodiment shown it is identical in both respects, except for the strips 14s, 14m bonded below).

If required, the intermediate element 14 can easily be removed and exchanged for a new one. Such exchange can be carried out by the same robot which is used for supplying and removing the wafers. After removal, the intermediate element can be cleaned with the same means and methods which are applied to cleaning the wafer 16.

This document does not describe any further characteristics of the carrier 10 or of the associated pot/the treatment device, because they can correspond to the state of the art (e.g. U.S. Pat. No. 5,421,056 and EP 0 444 714 B2).

1. A device comprising a carrier (10) for accommodating a wafer (16) within a wafer treatment device, wherein an exchangeable intermediate element (14) is arranged between the carrier (10) and the wafer (16).

2. The device according to claim 1, in which the intermediate element (14) is attached to the carrier (10) such that it follows the movements of the carrier (10).

3. The device according to claim 1, in which the intermediate element (14) is mechanically attached to the carrier (10).

4. The device according to claim 1, in which the intermediate element (14) is attached to the carrier by way of a suction means.

5. The device according to claim 1, in which the intermediate element (14) comprises apertures (14o) which, as far as gas-flow is concerned, establish a connection to a gas inlet or gas outlet unit in the region of the carrier (10).

6. The device according to claim 1, in which the intermediate element (14) is plate-shaped.

7. The device according to claim 1, in which the intermediate element (14) is disc-shaped.

8. The device according to claim 1, in which the intermediate element (14) is made of the same material as the wafer (16) to be treated.

9. The device according to claim 1, in which the intermediate element (14) is of the same size as, or of a larger size than the wafer (14) to be treated.

10. The device according to claim 1, in which the intermediate element (14) protrudes all around from the wafer to be treated.
